(19) United States
(12) Patent Application Publication
(10) Pub. No.: US 2013/0233246 A1
(43) Pub. Date: Sep. 12, 2013

(54) TREAT DISPENSER

(71) Applicant: Yueh Yu Wang, Kowloon (HK)

(72) Inventor: Yueh Yu Wang, Kowloon (HK)

(73) Assignee: TOPET INTERNATIONAL CO., LIMITED

(21) Appl. No.: 13/418,221

(22) Filed: Mar. 12, 2012

(51) Int. Cl. A01K 29/00; A01K 15/02

(52) U.S. Cl. 119/51.01; 119/719

(57) ABSTRACT

A treat dispenser having a sound producing element that may be activated in connection with dispensing treats from the dispenser. The treat dispenser may include a telescoping member and a housing member that may be displaced to dispense treats and emit a sound (e.g., click) from the sound producing element. The treat dispenser may be gripped by a user wherein the user may actuate the treat dispenser with one hand. The treat dispenser may be used in the training of an animal (e.g., clicker training)

### FIELD

The present disclosure is generally related to treat dispensers that may be used for training an animal, and in particular to ergonomic, easy to use treat dispensers having a telescoping member displaceable with respect to a housing member to dispense a treat and to actuate a sound producing element that may be used for training an animal.

### BACKGROUND

Through training, an animal may be conditioned to provide necessary or otherwise beneficial services to the trainer or other individual. For example, an animal may be trained to act as a service dog such that the animal may provide necessary assistance to individuals who are physically or mentally disadvantaged. Additionally, an animal may be trained in other contexts such, for example, as for entertainment purposes, for general obedience, or for any other behavior that a trainer wishes to impart on the animal.

One method for training an animal is commonly referred to as “clicker training ” Clicker training is a form of reward-based, positive reinforcement training that uses a stimulus (i.e., a sound or other sensory input) as a conditioned reinforcer or “bridge” to assist in shaping the animal's behavior. For example, a sound maker (i.e., a clicker) that produces a reproducible, consistent sound may be actuated upon the animal performing a behavior that is desired. After each click, the animal is rewarded with praise, an edible treat, or some other positive reinforcement. In this regard, the animal may develop a pavlovian response to the click, wherein the animal associates the click with the positive reinforcement the animal receives immediately following the click. The speed at which the trainer may click may be much faster than the time it takes to actually deliver the positive reward. As such, the click acts as a “bridge” that indicates immediately to the animal that they have performed as desired such that the reward will be delivered. In this regard, clicker training may speed training efforts as the desired behavior may be indicated to the animal or “marked” immediately.

However, clicker training may be awkward to implement for a trainer. For instance, when training dogs, for example, the trainer may often simultaneously hold the animal's leash, a treat, a clicker, other training aids, and/or other implements. In this regard, the actuation of the clicker and delivery of the treat while maintaining control over the other implements employed by the trainer may be cumbersome. This may lead to a delay in the click or delay in the subsequent delivery of the treat, either of which may retard the training process. Even in the case where a trainer utilizes pockets (e.g., pockets in the trainer's clothing or other accessory), accessing an item from the pocket of the user may still add time to the marking of a desired behavior with a click or may add time between the click and the delivery of the treat, thus slowing training progress.

### SUMMARY

In light of the foregoing, treat dispensers and methods are described herein that may be used for training an animal. The treat dispensers discussed herein may facilitate the training of an animal by allowing a stimulus (e.g., a click) to be produced and a reinforcing treat be dispensed with a single actuation of the treat dispenser. Accordingly, a desired behavior by the animal may be marked with the click and rewarded with a dispensed treat within a short time period to enhance the benefit of the clicker training of the animal. The treat dispensers described herein may be actuated by a trainer in a one-handed manner, thus freeing the trainer to utilize his or her other hand.

One aspect disclosed herein includes a dispenser for dispensing treats for an animal. The dispenser may include a housing member having a sidewall with an outer surface that is gripable by a user. The sidewall may have a dispensing opening provided therethrough. The dispenser also may include a telescoping member that is telescopically disposed with respect to the housing member. For example, at least a portion of the telescoping member may be disposed within the housing member and operable to telescopically move with respect to the housing member. The dispenser may include a sound producing element (e.g., a clicker). While embodiments of a treat dispenser including a sound producing element are discussed herein, it will be appreciated that any stimulus (e.g., any sensory stimulus such as a visual stimulus, or the like) may also be provided that is produced upon actuation of the treat dispenser. The sound producing element may be actuated to produce a sound (e.g., a click). The dispenser may also include a containment volume that is at least partially defined by the housing member and the telescoping member for containing a plurality of treats therein. The telescoping member and housing member may be displaceable with respect to one another to dispense at least one treat from the containment volume through the dispensing opening and actuate the sound producing element. Thus, the dispensing of the treat and the production of the sound may be substantially contemporaneous (e.g., substantially simultaneous).

A number of feature refinements and additional features are applicable to the first aspect. These feature refinements and additional features may be used individually or in any combination. As such, each of the following features that will be discussed may be, but are not required to be, used with any other feature or combination of features of the first aspect.

For example, in one embodiment, the treat dispenser may dispense a predetermined number of treats with each actuation. In this regard, the telescoping member may include a dispensing chute. The dispensing chute may be sized to as to contain the predetermined number of treats. Upon the displacement of the telescoping member and the housing member, the dispensing chute may be aligned with the dispensing opening, thus allowing for the treats disposed within the dispensing chute to be dispensed. The dispensing chute may include a gate, wherein the gate is closed upon the relative displacement of the telescoping member and the housing member. Accordingly, treats from the containment volume may be prevented from entering the dispensing chute when the telescoping member is displaced with respect to the housing member (i.e., in the actuated position). That is, the predetermined number of treats may be disposed between the gate and the dispensing opening prior to the displacement of the telescoping member and the housing member. When the gate is closed, the gate may block treats in the containment volume from entering the dispensing chute. However, when the gate is open, a predetermined number of treats may pass through the gate from the containment volume into the dispensing chute. Thus, upon subsequent actuation of the treat dispenser, treats that have become disposed in the dispensing chute may be dispensed. The treat dispenser may be biased to a non-dispensing position. Thus, the telescoping member and the housing member may return to an unactuated or non-dispensing position upon release of an actuation force by the user.

As described above, the treat dispenser may allow for one-handed operation by a user. In this regard, the outer surface of the housing member may be gripable by the fingers of a user such that the telescoping member is displaceable with respect to the housing member by the thumb of the user in a direction perpendicular to the fingers gripping the outer surface. Thus, a user flexing his or her thumb while gripping the treat dispenser may result in actuation of the treat dispenser to produce a sound and dispense a treat. The treat dispenser may be positioned with respect to gravity such that upon actuation of the treat dispenser, treats are urged by gravity from the dispensing opening. In one embodiment, the dispensing opening may be disposed on an end of the housing member opposite the end of the housing member that provides telescopic engagement of the telescoping member and the housing member. In this regard, treats may be dispensed from an end of the treat dispenser generally opposite the end of the treat dispenser contacted by the thumb of the user.

In one embodiment, the sound producing element may include a depressible button disposable adjacent to the thumb of the user when the user grips the outer surface of the housing member such that the depressible button may be actuated to produce the sound (e.g., a click) upon actuation of the treat dispenser by the thumb of the user. Alternatively, the sound producing element may be actuated by contact between the housing member and the telescoping member upon actuation of the treat dispenser.

Additionally, at least one of the housing member and the telescoping member may define a fill opening selectively accessible for filling the containment volume with treats. As such, once the supply of treats contained by the dispensing volume has been depleted, the containment volume may be replenished with treats. Accordingly, the treat dispenser may be reusable.

In one embodiment, an auxiliary sound producing element for producing a second sound (e.g., a whistle) different than the sound of the sound producing element (e.g., a click) may be provided on a treat dispenser. The auxiliary sound producing element may be useful, for example, for a secondary purpose during the training For instance, the auxiliary sound producing element may be used to train the animal to perform some certain action (e.g., coming to the trainer, performing some particular action, etc.). In one embodiment, the auxiliary sound producing element may emit a sound that is generally louder than the sound producing element. Thus, the auxiliary sound producing element may be used to command an animal at a distance from the trainer longer than the distance for which the sound producing element may be used.

A second aspect includes a method for dispensing a treat for an animal. The method may include actuating a treat dispenser by displacing a telescoping member with respect to a housing member, wherein the telescoping member is telescopically disposed with respect to a housing member. The method may also include sounding a noise from a sound producing element in response to the actuating and dispensing a treat from a containment volume at least partially defined by the housing member and the telescoping member.

A number of feature refinements and additional features are applicable to the second aspect. These feature refinements and additional features may be used individually or in any combination. As such, each of the following features that will be discussed may be, but are not required to be, used with any other feature or combination of features of the second aspect.

For example, the treat dispenser may generally be as described above with respect to the first aspect. The telescoping member may include a dispensing chute, and wherein upon the actuating of the treat dispenser, the dispensing chute is aligned with a dispensing opening provided through the housing member. The dispensing chute may include a gate, and the method may also include closing the gate upon the actuation of the treat dispenser. A predetermined number of treats may be disposed between the gate and the dispensing opening upon the actuation of the treat dispenser. When the gate is closed, the gate may block treats in the containment volume from entering the dispensing chute, and when the gate is open, a predetermined number of treat may pass through the gate from the containment volume into the dispensing chute.

One embodiment of the method may include gripping an outer surface of the housing member with the fingers of a user such that the telescoping member is displaceable with respect to the housing member by the thumb of the user in a direction perpendicular to the fingers gripping the outer surface during the actuating. Accordingly, upon disposing the housing member with respect to gravity, upon actuation of the treat dispenser, treats may be urged by gravity from the dispensing opening.

The sound producing element may include a depressible button disposable adjacent to the thumb of the user when the user grips the outer surface of the housing member such that the depressible button is actuated to produce the sound upon actuation of the treat dispenser by the thumb of the user. Alternatively, the sound producing element may be actuated by contact between one of the housing member and the telescoping member upon actuation of the treat dispenser.

A third aspect disclosed herein includes a method for training an animal. The method may include monitoring behavior of an animal for a desired behavior (e.g., sitting, laying down, coming when called, performing some task, or other desired behavior of the animal). The method further includes actuating a treat dispenser upon performance of said desired behavior. For example the treat dispenser may be according to any of the above disclosed aspects or embodiments without limitation. For instance, the actuating may include displacing a telescoping member with respect to a housing member to actuate a sound producing element and dispense treats from the treat dispenser. The method further includes delivering the dispensed treat to the animal.

A number of feature refinements and additional features are applicable to the third aspect. These feature refinements and additional features may be used individually or in any combination. As such, each of the following features that will be discussed may be, but are not required to be, used with any other feature or combination of features of the third aspect. For example, the method may include queuing the animal to perform the desired behavior before or at substantially the same time as the performance of the desired behavior.

### BRIEF DESCRIPTION OF THE FIGURES

FIG. 1 is a schematic view of an embodiment of a treat dispenser.

FIG. 2 is a schematic view of the embodiment of FIG. 1 in an actuated position.

FIG. 3 includes elevation views of another embodiment of a treat dispenser.

FIG. 4 is an exploded view of the embodiment of FIG. 3 in an unactuated state and an actuated state, respectively.

FIGS. 5A and 5B are cross sectional views of the embodiment of the treat dispenser FIG. 3 taken along section line 5-5 in FIG. 3.

FIG. 6 is a perspective view depicting the end wall of the embodiment of the treat dispenser FIG. 3.

FIG. 7 is a perspective view of the top of the treat dispenser shown in FIG. 3 with a filling lid exploded from the treat dispenser.

FIG. 8 depicts an embodiment of a lanyard and belt clip attachable to the embodiment of the treat dispenser FIG. 3.

FIG. 9 includes elevation views of another embodiment of treat dispenser.

FIG. 10 is a perspective view of the treat dispenser of FIG. 9 with the telescoping member exploded from the housing member.

FIG. 11 shows the treat dispenser FIG. 9 with a filling lid in an open position.

FIG. 12 depicts a secondary or auxiliary sound producing element of the embodiment depicted in FIG. 9.

FIG. 13 depicts an embodiment of a lanyard for use with the embodiment of FIG. 9.

FIG. 14 depicts the embodiment of FIG. 9 being held by a user.

FIG. 15 includes elevation views of still another embodiment of a treat dispenser.

FIG. 16 is a perspective view of the treat dispenser of FIG. 15 in an exploded state.

FIGS. 17A-17C are cross sectional views of the embodiment of FIG. 15 in various configurations.

Common reference numerals are used to indicate like elements through the drawings and detailed description

### DETAILED DESCRIPTION

The following description is not intended to limit the invention to the form disclosed herein. Consequently, variations and modifications commiserate with the following teachings, skill, and other knowledge of the relevant art, are within the scope of the present invention. The embodiments described herein are further intended to explain modes known of practicing the invention and to enable others skilled in the art to utilize the invention in such, or other embodiments, and with various modifications required by the particular application(s) or use(s) of the invention.

The present description is generally related to treat dispensers having a sound producing element such that upon actuation of the dispenser, a treat may be dispensed from the dispenser and a sound may be produced by the sound producing element. The treat dispensers disclosed herein may be particularly suited to the field of an operant conditioning method such as “clicker training ” The treat dispensers described herein may allow a trainer to provide a sensory stimulus to the animal being trained while at the same time, or in a very short time thereafter, allowing a treat to be dispensed to the animal as positive reinforcement. In this regard, the trainer may be able to hold a treat dispenser as described herein with one hand in order to both produce the sensory stimulus (e.g., a click) and dispense a treat to provide to an animal as positive reinforcement. Accordingly, the number and/or complexity of devices or objects a trainer must handle may be reduced, thereby improving the training experience for the trainer and allowing an improved training experience.

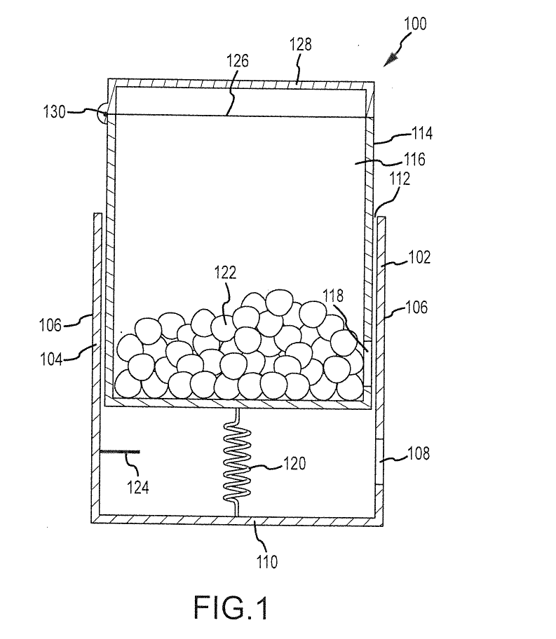

FIG. 1 depicts a schematic view of an embodiment of a treat dispenser 100. The dispenser 100 may include a housing member 102 including a sidewall 104. The sidewall 104 may have an outer surface 106 that is gripable by a user. Furthermore, the sidewall 104 may have a dispensing opening 108 passing through the sidewall 104. The housing member 102 may also include an end wall 100 disposed on an opposite end of the housing member 102 as a housing opening 112.

A telescoping member 114 may be telescopically disposed with respect to the housing member 102. For example, the telescoping member 114 may pass through the housing opening 112 provided opposite the end wall 110 of the housing member 102. While not shown in FIG. 1, the telescoping member 114 and/or housing member 102 may include features in order to maintain the telescoping member 114 in telescopic relation with respect to the housing member 102. For example, the telescoping member 114 and housing member 102 may be sized and/or include features to prevent the telescoping member 114 from being removed from the housing opening 112 of the housing member 102.

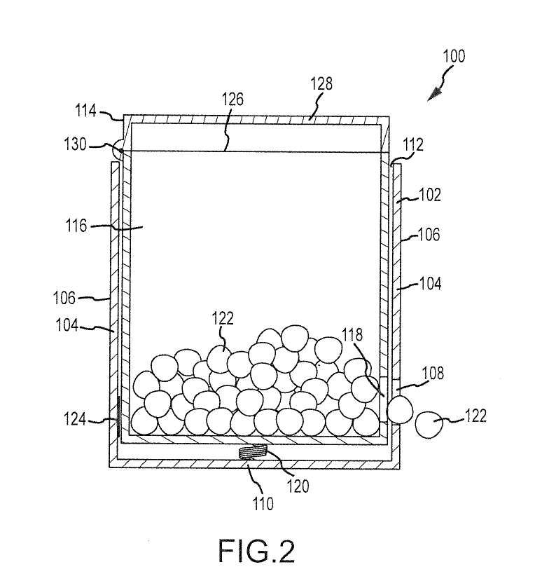

The telescoping member 114 and/or the housing member 102 may include a containment volume 116. For example, as shown in FIG. 1, the telescoping member 114 substantially defines the containment volume 116. Alternatively, the housing member 102 may define at least a portion of the containment volume 102. In any regard, the containment volume 116 may be sized so as to hold a quantity of treats 122 therein. For example, the containment volume 116 may be sized to hold at least about 20 treats therein. Alternatively, the containment volume 116 may be sized to hold more than about 20 treats such as, for example, 30 or more treats, 35 or more treats, or even 40 or more treats. In the depicted embodiment, a containment volume opening 118 may be provided in the telescoping member 114. As shown in FIG. 1, the treat dispenser may be positioned in an unactuated position, wherein the containment volume opening 118 is not aligned with the dispensing opening 108. Thus, the treats 122 may be contained within the containment volume 116 so that the treats 122 cannot pass to the exterior of the dispenser 100. With further reference to FIG. 2, the treat dispenser 100 may be actuated (i.e., moved to an actuated position) with respect to the housing member 102 such that the telescoping member 114 is displaced so as to align the containment volume opening 118 and the dispensing opening 108. A biasing member 120 may bias the treat dispenser 100 to the unactuated position as shown in FIG. 1. As such, absent an actuation force being applied to one of the telescoping member 114 and/or housing member 102 to overcome a biasing force of the biasing member 120, the treat dispenser 100 may remain in the unactuated position such that the containment volume 116 may be secure so no treats 122 are allowed to escape from the containment volume 116.

Additionally, a sound producing element may be provided. For example, the sound producing element maybe a deflectable reed (e.g., a metallic reed 124) that omits a loud sharp clicking sound upon deflection of the metal reed 124. Such metallic reeds 124 are often using in traditional clickers used for clicker training It will be understood that other sound producing elements other than the metallic reed 124 depicted may be utilized without limitation. In any regard, upon movement of the telescoping member 114 with respect to the housing member, the metallic reed 124 may be deflected so as to admit a sound (e.g., a click). As described above, the activation of the sound producing element may coincide in close temporal proximity to the dispensation of treats 122 from the containment volume 116 to an exterior of the dispenser 100. For example, the production of the sound and the dispensing of the treats 122 may occur substantially contemporaneously (e.g., simultaneously).

With further reference to FIGS. 1 and 2, the telescoping member 114 may have a filling opening 126 that may be selectively opened to fill the containment volume 116 with treats 122. For example, the filling opening 126 may be covered by a fill cap 128. The fill cap 128 may be selectably displaceable away from the fill opening 126 so as to access the containment volume 116 and provide treats 122 therein. In the embodiment depicted, the fill cap 128 may be attached to the telescoping member 114 by way of a hinge 130. In this regard, the fill cap 128 may be pivotal about the hinge 130 so as to move away from the filling opening 126 to allow the containment volume 116 to be filled with treats 122.

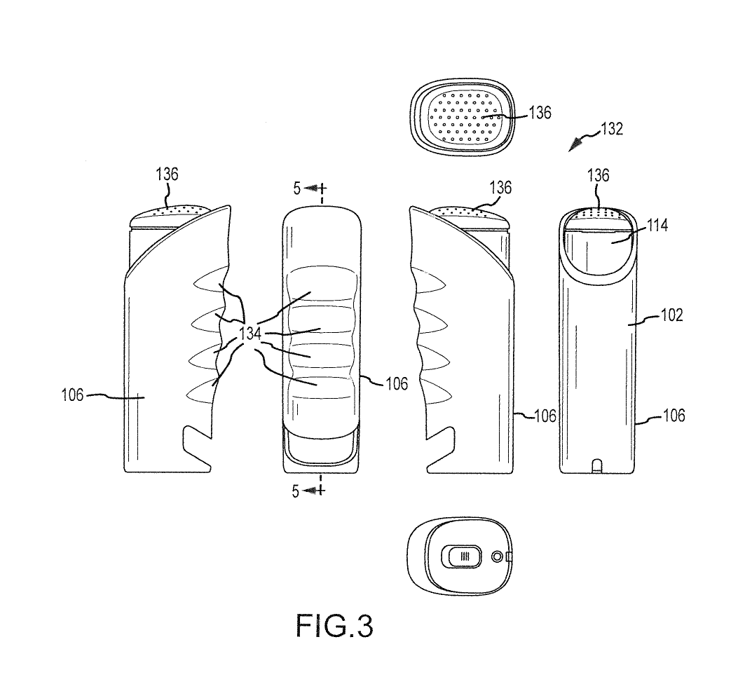

With reference to FIG. 3, another embodiment of a treat dispenser 132 is depicted. The treat dispenser depicted in FIG. 3, like the dispenser shown in FIGS. 1 and 2 may have a telescoping member 114 disposed with respect to housing member 102. The housing member 102 may include features along the outer surface 106 that correspond to the hand of a user (e.g., dimples 134 in which the fingers of the user may be disposed when the dispenser 132 is held by a user). In this regard, the treat dispenser 132 may be held such that the fingers of a user grip the outer surface 106 of the housing member 102 allowing the thumb to rest on the free end 136 of the telescoping portion 114. In this regard, displacement of the thumb with respect to the fingers of the user gripping the housing member 102 may displace the telescoping member 114 with respect to the housing member 102 so as to activate a sound producing element (not shown in FIG. 3) and actuate the dispenser 132, for example, as described above with respect to FIGS. 1 and 2.

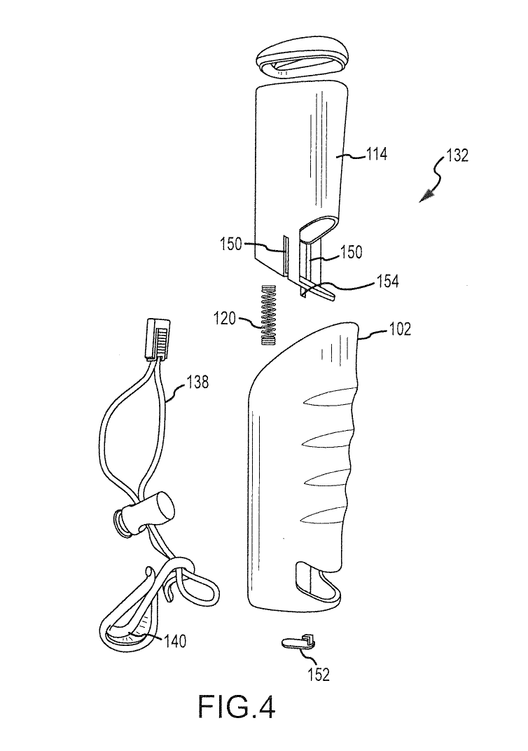

FIG. 4 depicts an exploded view of the embodiment of the treat dispenser shown 132 in FIG. 3. A biasing member 120 (e.g., a coil spring) may be disposed between the housing member 102 and telescoping member 114 to bias the treat dispenser 132 to an actuated position. Also shown in the exploded FIG. 4 is another embodiment of a sound producing device 142, the operation of which will be described in further detail below. Additionally as depicted in FIG. 4, a lanyard 138 and/or belt clip 140 may be provided as options for a user to secure the treat dispenser 132 to his or her person, clothing, etc.

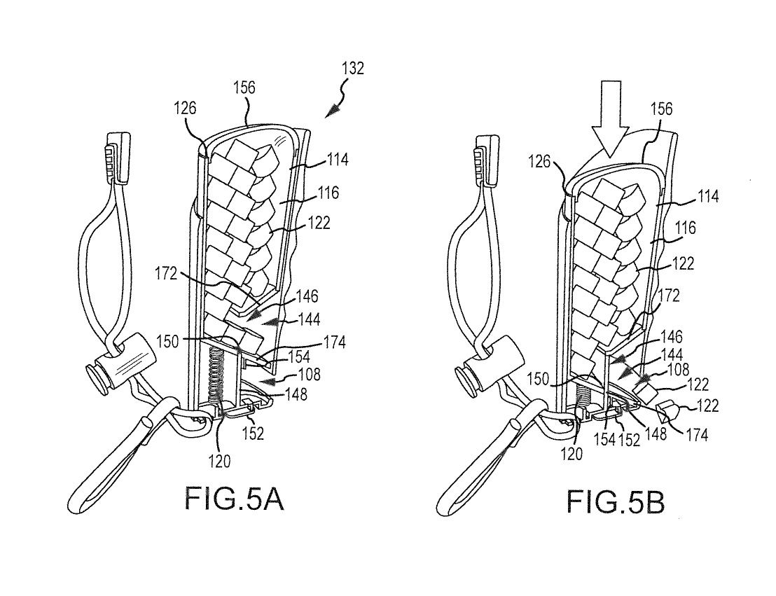

With further reference to FIGS. 5A and 5B, a cross sectional view taken along section line 5-5 in FIG. 3 is depicted. The treat dispenser 132 is shown in an unactuated position in FIG. 5A and in an actuated position FIG. 5B. The telescoping member 114 may include a dispensing chute 144 that, when the treat dispenser 132 is in the unactuated position the dispensing chute 144 is not aligned (e.g., offset) with respect to the dispensing opening 108 of the housing member 102. As such, a number of treats 122 may become disposed in the dispensing chute 144 when in the unactuated position shown in FIG. 5A. Upon displacing the telescoping member 114 with respect to the housing member 102, the dispensing chute 144 may be aligned with the dispensing opening 108 such that any treats 122 disposed in the dispensing chute 144 may exit the dispensing opening 108 when the treat dispenser 132 is in the actuated position as shown in FIG. 5B.

Additionally, the dispensing chute 144 may include a gate 146 that, when in the unactuated position, is open. The gate 146 may generally be defined between a baffle 172 extending into the containment volume 116 and a floor 174 of the containment volume 116. As shown in FIG. 5A, a gate projection 148 may extend from the end wall 110 of the housing member 102 such that a portion of the gate projection 148 is disposed in a slot 150 (best seen in FIG. 4) provided in the telescoping member 114 through the floor 174 and adjacent to the gate 146. In this regard, when the telescoping member 114 is displaced with respect to the housing member 102, the gate projection 148 extending from the end wall 110 housing member 102 may pass through the slot 150 provided in the telescoping member 114 to extend across the dispensing chute 144 between the floor 174 and the baffle 172 to prevent treats 122 in the containment volume 106 from entering the dispensing chute 144 when in the actuated position.

The volume of the dispensing chute 144 downstream of the gate 146 may be sized to hold a predetermined number of treats 122. As such, when the treat dispenser 132 is displaced from the unactuated position to the actuated position, the predetermined number of treats 122 may be dispensed. The dispensing chute 144 may be sized to hold one or more treats 122. For example, the dispensing chute 144 may hold at least about one treat 122 and no more than about four treats 122. In one embodiment, the dispensing chute 144 may hold, and therefore dispense, about three treats 122 per actuation of the treat dispenser 132.

Also shown in FIGS. 5A and 5B is another embodiment of a sound producing element 152. As shown in FIG. 5A, the telescoping member 114 may have an actuation projection 154 extending from the floor 174 toward the end well 110 housing member 102. The sound producing element 152 may extend through the end wall 110 of the housing member 102. Upon displacement of the telescoping member 114 with respect to the housing member, the actuation projection 154 may contact the sound producing element 152 so as to produce sound there from. For example, the actuating element 154 may have a flange that interacts with a corresponding flange of the sound producing element 152. In this regard, the flanges may contact one another once the telescoping member 114 is moved with respect to the housing member 102. Further movement of the telescoping member 114 with respect to the housing member 102 may result in one or both of the flanges elastically deforming and subsequently snapping back into position once the flanges have passed by one another so as to produce a clicking sound.

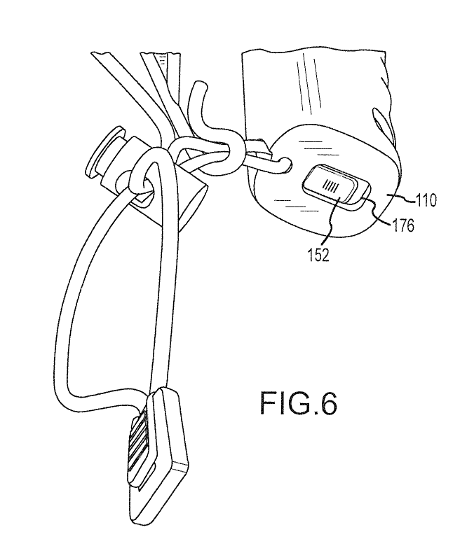

As shown in FIG. 6, the sound producing element 152 may be selectably positionable with respect to a slot 176 in the end wall 110 such that when in the position shown in FIG. 6, 5A and 5B, the sound producing element 152 is contacted so as to produce sound upon actuation of the telescoping member 114. However, the sound producing element 152 may be moved in the slot 176 such that the sound producing element 152 extending through the end wall 110 is moved away from the actuating element 154. Accordingly, the sound producing element 152 may be moved between an on and off position such that when in the off position the sound producing element 152 is not contacted by the actuation projection 154 shown in FIGS. 5A and 5B so as to not omit a sound. Accordingly, the treat dispenser 132 may be used without the sound producing element 152, if so desired.

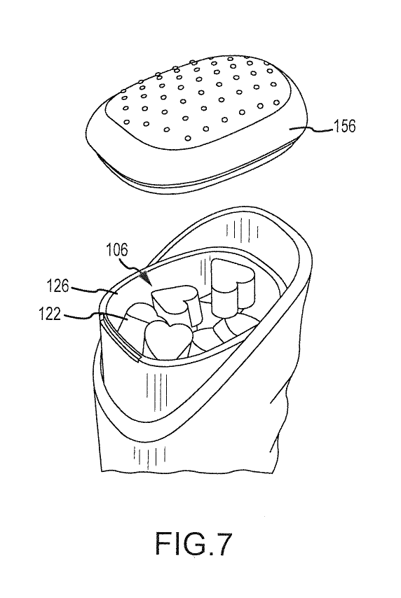

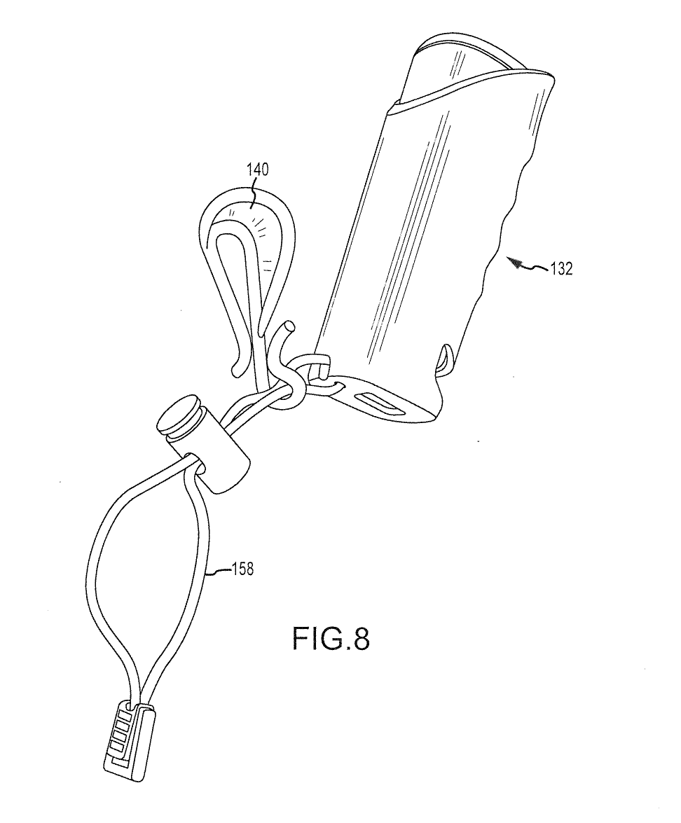

FIG. 7 depicts one embodiment of a fill opening 156 that is selectively accessible for filling the containment volume 106 with treats 122. In the embodiment shown in FIG. 7, the fill opening 156 may be selectively coverable with a cap 156 that is removable from the fill opening 106 such that treats 122 may be inserted into the containment volume 106. FIG. 8 depicts another view of the lanyard 138 and the belt clip 140 that may be attached to the housing member 102.

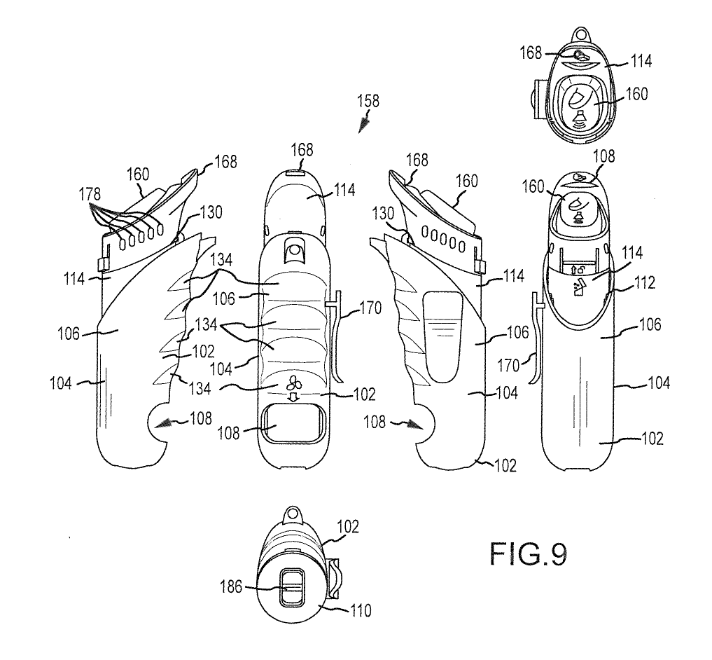

FIG. 9 depicts another embodiment of a treat dispenser 158. The treat dispenser 158 depicted in FIG. 9 may have a sound producing element 160 provided adjacent the filling opening 156 of the treat dispenser 158. For example, as depicted, the sound producing element 160 may be provided on a fill cap 128 that is pivotally attached to the telescoping member 144 at a hinge 130. In this regard, the sound producing element 160 may be disposed adjacent to the thumb of a user actuating the treat dispenser 158 and on an opposite side of the treat dispenser 158 away from the dispensing opening 108. A number of ports 178 may be provided in the fill cap 128. The ports 178 may provide openings that allow the sound produced by the sound producing element 160 to more clearly emanate from the sound producing element 160 (e.g., such that the click is louder).

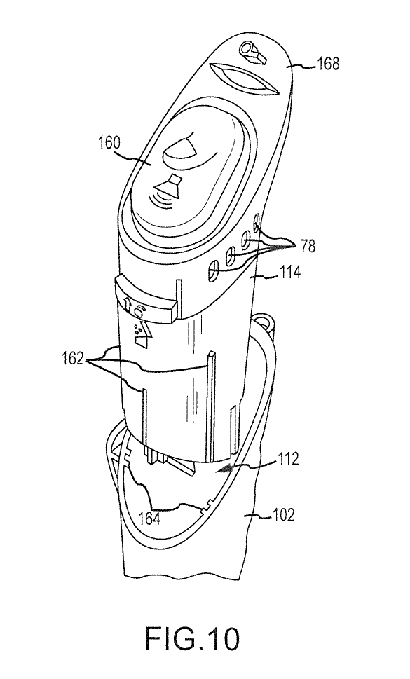

FIG. 10 depicts an exploded view of the treat dispenser 158 shown in FIG. 9. As can be appreciated in FIG. 10, a number of tabs 162 may extend from the telescoping member 114 that engage corresponding grooves 164 provided in the housing member 102. In this regard, the telescoping member 114 may be limited from rotating with respect to the housing member 102. Additionally, the tabs 162 and grooves 164 may coordinate so as to prevent the telescoping member 114 from being removed from the housing member 102 once so inserted. Also, as shown in FIG. 9, the treat dispenser 158 may include a switch 186. The switch 186 may be used to selectively prevent actuation of the treat dispenser 158. That is, the switch 186 may be toggled between an “on” and “off” position. When in the “on” position, the telescoping member 114 may be allowed to be displaced with respect to the housing member 102 as described above to allow for dispensation of treats 122 from the containment volume 116. When in the “off” position, the telescoping member 114 may be locked with respect to the housing member 102 to prevent actuation of the treat dispenser 158. For the embodiment of the treat dispenser 158 shown in FIG. 9, preventing the telescoping member 114 from being displaced with respect to the housing member 102 may still allow for actuation of the sound producing element 160 in that the sound producing element 160 may be independently actuated absent movement of the telescoping member 114. However, in alternative embodiments (e.g., the treat dispenser 132 of FIG. 3), where the sound producing element is actuated by movement of the telescoping member 114 with respect to the housing member 102, locking the telescoping member 114 with respect to the housing member 102 may also disable the sound producing element.

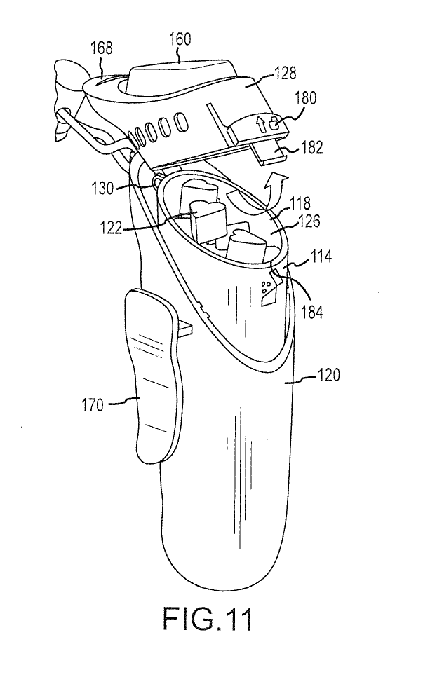

FIG. 11 depicts the filling opening 156 of the treat dispenser 158 including a top portion 166 of the telescoping member 114 that may be hingeably attached to and pivotally movable respect to the containment volume 106 so as to expose the filling opening 156 so treats 122 may be provided therein. In this regard, the top portion 166 including the sound producing element 160 may form the fill cap 128 that may be secured with respect to the fill opening 126 to close the containment volume 116. The fill cap 128 may include a clasp 182 that engages a lip 184 of the containment volume opening 118. The clasp 182 may be disengaged from the lip 184 by depressing the button 180. This may free the fill cap 128 from the containment volume opening 118 such that the fill cap 128 may be moved away from the containment volume opening 118 (e.g. pivoted away therefrom about the hinge 130).

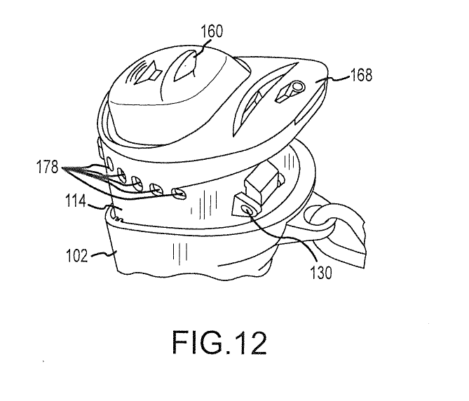

With respect to FIG. 12, a secondary sound producing element 168 is shown. The secondary sound producing element 168 may be used in addition to or as an alternative to the sound producing element 160 (e.g., a clicker button provided on the telescoping member 114). The secondary sound producing element 168 may be useful for a secondary purpose during the training For example, the secondary sound producing element 168 may be used to train the animal to perform some certain action (e.g., coming to the trainer, performing some particular action, etc.). In one embodiment, the secondary sound producing element 168 may emit a sound that is louder than the sound producing element 160. Thus, the auxiliary sound producing element 168 may be used to command an animal from a distance greater than for which the sound producing element 160 may be used.

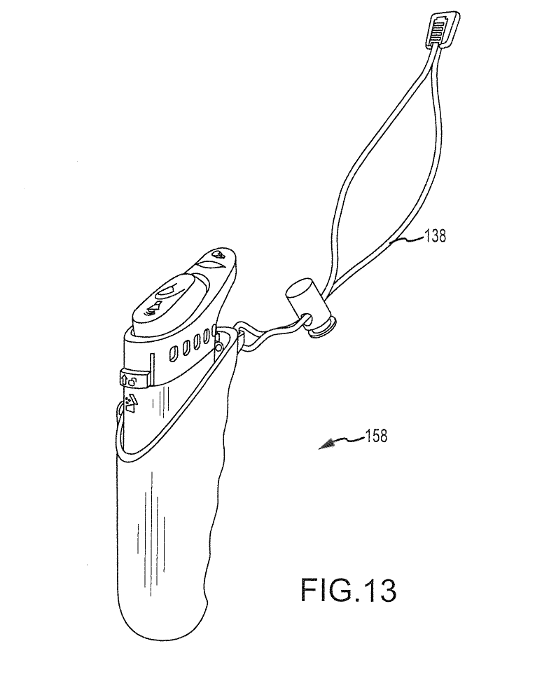

With respect to FIG. 13, the embodiment of the treat dispenser 158 may also include a lanyard 138 that may be used by a trainer to secure the dispenser to themselves or a portion of their clothes. Also, the treat dispenser 158 may include a belt clip 170 (e.g., as shown in FIG. 11). The belt clip 170 may be provided integrally with the housing member 102.

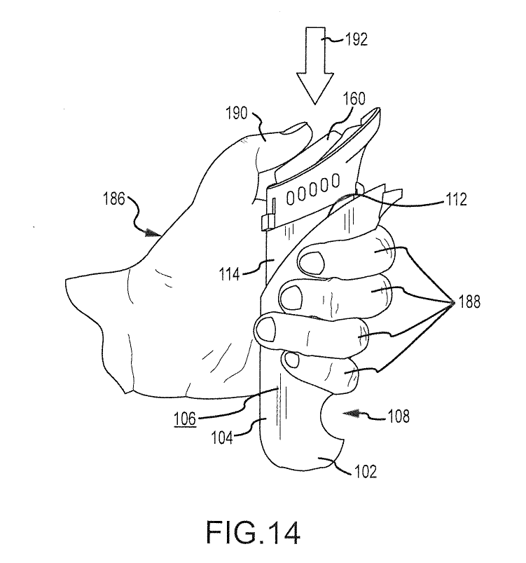

With further reference to FIG. 14, the treat dispenser 158 may be held by the user as shown. The user may hold the treat dispenser 158 in a single hand 186 such that the fingers 188 of the user wrap around the outer surface 106 of the housing member 102. For example, the user's fingers 188 may be disposed in the dimples 134 defined in the housing member 102 as shown above with respect to FIG. 9, etc. When the user grasps the housing member 102 such that the user's fingers 188 are wrapped about the housing member 102, the user's thumb 190 may be disposed adjacent to the telescoping member 104. As used herein, the term fingers is used to denote the index through the small finger (i.e., the finger disposed on the most ulnar side of the user's hand 186). That is, for purposes of this disclosure the user's thumb 190 is described separately from the fingers 188.

In any regard, the user may flex his or her thumb 190 in the direction of the arrow 192 to displace the telescoping portion 104 with respect to the housing member 102. In the embodiment depicted in FIG. 14, the user's thumb 190 may also be disposed adjacent to the sound producing element 160. Accordingly, a treat 122 may be dispensed from the dispensing opening 108 and the sound producing element 160 may be activated to produce a sound as described above. In this regard, the thumb 190 of the user may be displaced in a direction generally perpendicular to the fingers 188 of the user wrapped about the housing member 102. The displacement of the thumb 190 in a direction perpendicular to the fingers 188 may be an ergonomic movement such that the user may repetitively actuate the dispenser 158 with minimal fatigue. Also, due in part to the structure of the dispenser 158, the user may operate the dispenser 158 in a one-handed manner, thus freeing the user's other hand to perform other tasks. Furthermore, while the embodiment of the treat dispenser 158 is shown as being held in the manner described above by the user, it will be understood that the other embodiments of the treat dispenser discussed herein may be held and/or operated in a similar manner as described with respect to the treat dispenser 158.

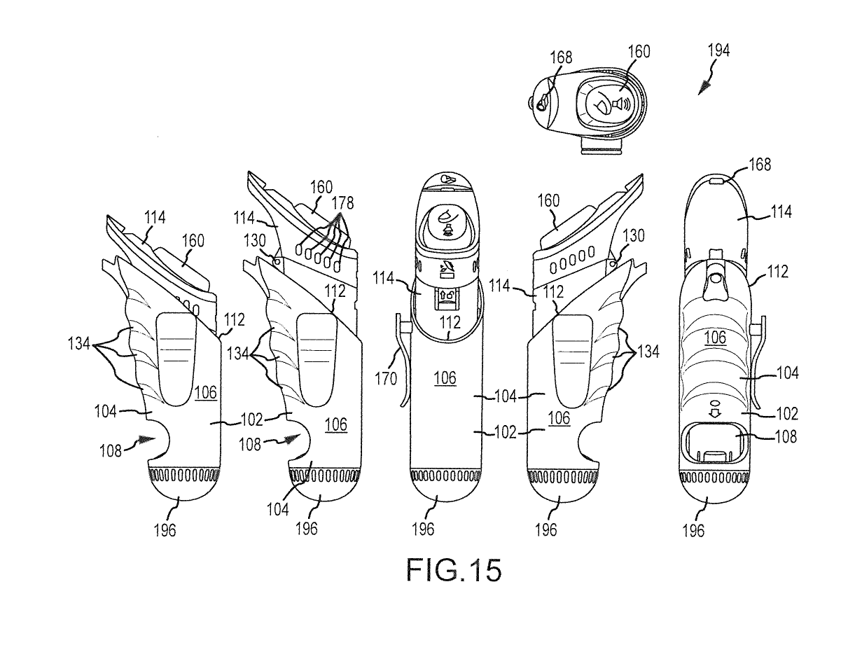

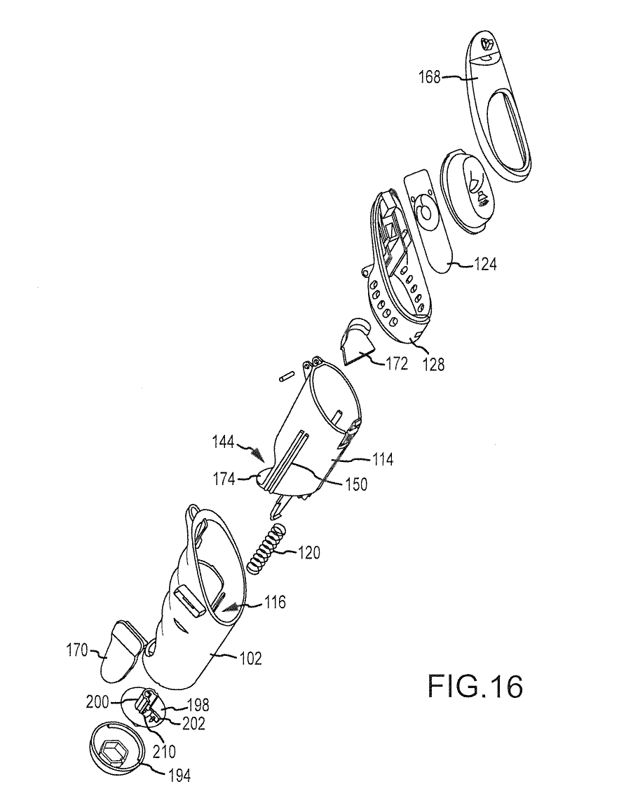

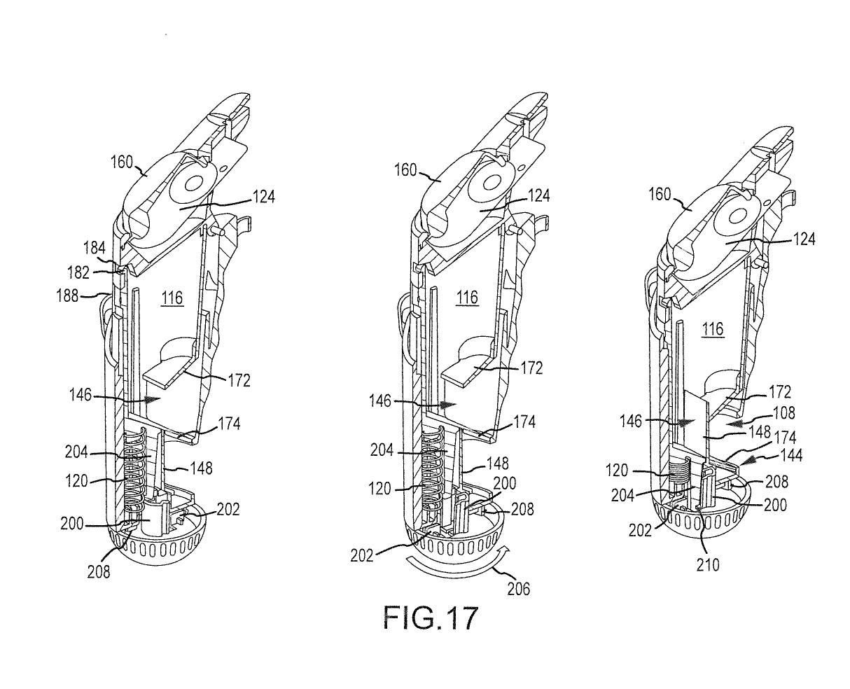

Still another embodiment of a treat dispenser 194 is shown in FIG. 15. The treat dispenser 194 may generally include features similar as the other embodiments of treat dispensers described above. Thus, the elements and features of the above-described treat dispensers common to the treat dispenser 194 are denoted with the same reference numerals used in the description above. For example, with further reference to FIGS. 16 and 17A-17C, the treat dispenser 194 may include similar structures and features related to the dispensation of a predetermined number of treats 122 from the dispenser 194 upon each actuation of the treat dispenser 194. In this regard, as shown best in FIGS. 17A-17C, the treat dispenser 194 may include a gate 146 defined in a dispensing chute 144. As such, upon actuation of the treat dispenser 194, a gate projection 148 may extend through a slot 150 in the telescoping member 114 to span between a floor 174 and a baffle 172 to close off a containment volume 116 as described above with respect to FIGS. 5A and 5B.

Also, the treat dispenser 194 may be lockable to prevent displacement of the telescoping member 114 with respect to the housing member 102. In this regard, a rotatable end portion 196 may be provided on the treat dispenser 194 that is capable of being moved (e.g., selectively rotated) to lock the treat dispenser 194 to prevent displacement of the telescoping member 114 with respect to the housing member 102 or to unlock the treat dispenser 194 to allow for displacement of the telescoping member 114 with respect to the housing member 102, as will be discussed in greater detail below.

With additional reference to FIG. 16, the treat dispenser 194 is shown in an exploded state. As can be appreciated in FIG. 16, the rotatable end portion 196 may be engaged with a locking hub 198. In this regard, the locking hub 198 may be rotationally fixed relative to the rotatable end portion 196 such that the rotatable end portion 196 and the locking hub 198 are rotationally moved upon rotation of the rotatable end portion 196. The locking hub 198 may have a locking post 200 extending therefrom. The locking post 200 may be, for example, generally semicircular in profile. With additional reference to FIGS. 17A-17C, when in a locked position (as shown in FIG. 17A), the locking post 200 may be disposed with respect to a finger 204 extending from the telescoping member 114. For example, the locking post 200 may about the finger 204 such that the telescoping member is prevented from being displaced relative to the housing member 102.

The rotatable end portion 196 may be rotated in the direction indicated by arrow 206 in FIG. 17B. For example, the rotatable end portion 196, and in turn the locking hub 198 may be rotated such that the locking post 200 is displaced away from the finger 204. For example, the semicircular nature of the locking post 200 may allow for the finger 204 to become free from the locking post 200 upon rotation of the locking post 200 along with the locking hub 198 and the rotatable end portion 196 (e.g., upon rotation of the locking post about 180 degrees). Thus, the locking post 200 may be disposed as shown in FIG. 17B, such that the finger 204 is not contacted by the locking post 200 and can be moved with respect thereto to the actuated position as shown in FIG. 17C. It will be appreciated that the locking hub 198 may include an aperture 210 through which the finger 204 may pass when the telescoping member 114 is displaced with respect to the housing member 102.

Additionally, the locking hub 198 may include a stop 202 that rotates along with the locking hub 198 and rotatable end portion 196. The stop 202 may contact one of two tabs 208 provided on the housing assembly 102 to define the extent of rotational travel of the locking hub 198 between the locked position and the unlocked positions shown in FIGS. 17A and 17B, respectively.

As can also be appreciated from FIGS. 16 and 17A-17B, the sound producing element 160 may include a metallic reed 124 as described above with respect to FIGS. 1 and 2. The metallic reed 124 may be affixed at one end thereof within the fill cap 128 that is pivotally moveable about the hinge 130 to expose the fill opening 126 through which treats 122 may be deposited into the containment volume 116. Accordingly, a button 210 may be pressed so that the button 210 contacts and deflects the metallic reed 124 to produce a “click” sound.

Any of the treat dispensers described herein may be used in the training of an animal. The method may include monitoring the animal for performance of a desired behavior. The monitoring may include awaiting the performance of a desired behavior (e.g., sitting, lying down, or other naturally performed activities) and/or be accompanied by a command. The command may take the form of a hand signal, a verbal command, a sound command, or other queue to the animal. In any regard, upon performance of the desired behavior, the treat dispenser 100 may be actuated as described above. Upon actuation of the treat dispenser 100, a sound producing element may sound a noise that marks the desired behavior of the animal. The actuation of the treat dispenser may also include dispensation of treats from the containment volume. The dispensed treats may be delivered to the animal. The delivery of the treats to the animal may be direct (e.g., the treats may be dispensed onto the ground and retrieved by the animal) or by way of the trainer (e.g., the treats may be dispensed into the hand of the trainer and then provided to the animal). The foregoing steps may be repeated a number of times until the animal performs the desired behavior in response to a queue or simply to reinforce the performance of the desired behavior. The treat dispenser may be refilled upon dispensation of all or a portion of the treats in the containment volume. The refilling of the containment volume may include moving or removing the fill cap and depositing additional treats within the containment volume.

While the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences). Accordingly, it should be understood that only the preferred embodiment and variants thereof have been shown and described and that all changes and modifications that come within the spirit of the invention are desired to be protected.

What is claimed is:

1. A dispenser for dispensing treats for an animal, the dispenser comprising:
a housing member having a sidewall with an outer surface that is gripable by a user, the sidewall having a dispensing opening provided therethrough;
a telescoping member telescopically disposed with respect to the housing member;
a sound producing element that is activateable to produce a sound;
a containment volume at least partially defined by the housing member and the telescoping member for containing a plurality of treats therein;
wherein the telescoping member and housing member are displaceable with respect to one another to actuate the dispenser, wherein at least one treat is dispensed from the containment volume through the dispensing opening and the sound producing element is activated.

2. The dispenser according to claim 1, wherein the telescoping member comprises a dispensing chute, and wherein upon actuation of the dispenser, the dispensing chute is aligned with the dispensing opening.

3. The dispenser according to claim 2, wherein the dispensing chute comprises a gate, wherein the gate is closed upon the actuation of the dispenser.

4. The dispenser according to claim 3, wherein a predetermined number of treats are disposed between the gate and the dispensing opening upon the actuation of the dispenser.

5. The dispenser according to claim 4, wherein when the gate is closed, the gate blocks treats in the containment volume from entering the dispensing chute.

6. The dispenser according to claim 4, wherein when the gate is open, a predetermined number of treats pass through the gate from the containment volume into the dispensing chute.

7. The dispenser according to claim 1, wherein the outer surface housing member is gripable by the fingers of a user such that the telescoping member is displaceable with respect to the housing member by the thumb of the user in a direction perpendicular to the fingers gripping the outer surface.

8. The dispenser according to claim 7, wherein the housing member is disposable with respect to gravity such that upon actuation of the dispenser treats are urged by gravity from the dispensing opening.

9. The dispenser according to claim 8, wherein the sound producing element comprises a depressible button disposable adjacent to the thumb of the user when the user grips the outer surface of the housing member such that the depressible button is activated to produce the sound upon actuation of the dispenser by the thumb of the user.

10. The dispenser according to claim 1, wherein the sound producing element is activated by contact between the housing member and the telescoping member upon displacement of the housing member or telescoping member.

11. The dispenser according to claim 1, wherein at least one of the housing members and the telescoping member define a fill opening selectively accessible for filling the containment volume with treats.

12. The dispenser according to claim 11, wherein the dispensing opening is disposed on an end of the housing member opposite the end of the housing member at which the telescoping member and the housing member are telescopically engaged.

13. The dispenser according to claim 1, further including:
a secondary sound producing element for producing a second sound different than the sound of the sound producing element.

14. The dispenser according to claim 1, wherein the treat dispenser is biased to an unactuated position.

15. A method for dispensing treat for an animal, the method comprising:
displacing a telescoping member with respect to a housing member, wherein the telescoping member is telescopically disposed with respect to the housing member;
actuating the dispenser in response to the displacing;
sounding a noise from a sound producing element in response to the actuating; and
dispensing a treat from a containment volume at least partially defined by the housing member and the telescoping member.

16. A method according to claim 15, wherein the telescoping member comprises a dispensing chute, and wherein upon the actuating of the dispenser, the dispensing chute is aligned with a dispensing opening provided through the housing.

17. The method according to claim 16, wherein the dispensing chute comprises a gate, and the method further comprises:
closing the gate upon the actuation of the dispenser.

18. The method according to claim 17, wherein a predetermined number of treats are disposed between the gate and the dispensing opening upon the actuation of the dispenser.

19. The method according to claim 18, wherein when the gate is closed, the gate blocks treats in the containment volume from entering the dispensing chute.

20. The method according to claim 19, wherein when the gate is open, a predetermined number of treats pass through the gate from the containment volume into the dispensing chute.

21. The method according to claim 15, further comprising:
gripping an outer surface of the housing member with the fingers of a user such that the telescoping member is displaceable with respect to the housing member by the thumb of the user in a direction perpendicular to the fingers gripping the outer surface during the actuating.

22. The method according to claim 21, further comprising:
disposing the housing member with respect to gravity such that upon actuation of the dispenser, treats are urged by gravity from the dispensing opening.

23. The method according to claim 22, wherein the sound producing element comprises a depressible button disposable adjacent to the thumb of the user when the user grips the outer surface of the housing member such that the depressible button is activated to produce the sound upon actuation of the dispenser.

24. The method according to claim 15, wherein the sound producing element is activated by contact between the housing member and the telescoping member upon actuation of the dispenser.

25. The method according to claim 15, wherein at least one of the housing member and the telescoping member define a fill opening selectively accessible for filling the containment volume with treats.

26. The method according to claim 25, wherein the dispensing opening is disposed on an end of the housing member opposite the end of the housing member at which the telescoping member and the housing member are telescopically engaged.

27. The method according to claim 15, further including operating a secondary sound producing element for producing a second sound different than the sound of the sound producing element.

28. The method according to claim 15, further comprising:
biasing the dispenser to an unactuated position.

29. A method for training an animal, the method comprising:
monitoring behavior of an animal for a desired behavior;
actuating a treat dispenser upon performance of said desired behavior, wherein said actuating includes displacing a telescoping member with respect to a housing member to activate a sound producing element and dispense treats from the treat dispenser; and
delivering the dispensed treat to the animal.

30. A method according to claim 30, further comprising:
queuing the animal to perform the desired behavior before or at substantially the same time as the performance of the desired behavior.
